(19) United States
(12) Patent Application Publication
(10) Pub. No.: US 2007/0088681 A1
(43) Pub. Date: Apr. 19, 2007

(54) Method and system for offsetting network latencies during incremental searching using local caching and predictive fetching of results from a remote server

(75) Inventors: Murali Aravamudan, Windham, NH (US); Sashikumar Venkataraman, Bangalore (IN); Rakesh Barve, Bangalore (IN); Satyanarayanan Ramaswamy, Windham, NH (US); Ajit Rajasekharan, West Windsor, NJ (US)

Correspondence Address: WILMER CUTLER PICKERING HALE AND DORR LLP, 60 STATE STREET, BOSTON, MA, 02109, US

(73) Assignee: Veveo, Inc., Andover, MA (US)

(21) Appl. No.: 11/356,788

(22) Filed: Feb. 17, 2006

Related U.S. Application Data
(60) Provisional application No. 60/727,561, filed on Oct. 17, 2005.

(51) Int. Cl. G06F 17/30

(52) U.S. Cl. 707/3

(57) ABSTRACT

A method and system are provided for offsetting network latencies in an incremental processing of a search query entered by a user of a device having connectivity to a remote server over a network. The search query is directed at identifying an item from a set of items. In accordance with the method and system, data expected to be of interest to the user is stored in a local memory associated with the device. Upon receiving a key entry or a browse action entry of the search query from the user, the system searches the local memory associated with the device to identify results therein matching the key entry or browse action entry. The results identified in the local memory are displayed on a display associated with the device. Also upon receiving a key entry or a browse action entry of the search query from the user, the system sends the search query to the remote server and retrieves results from the remote server matching the key entry or browse action entry. The results from the remote server are merged with the results from the local memory for displaying on the display. The process is repeated for additional characters or browse actions entered by the user when he or she does not find the desired item on the display.

### RELATED APPLICATIONS

The present application is based on and claims priority from U.S. Patent Application Ser. No. 60/727,561 filed on Oct. 17, 2005 and entitled “Method And System For Predictive Prefetch And Caching Of Results To Offset Network Latencies During Incremental Search With Reduced User Input On Mobile Devices,” which is incorporated by reference herein in its entirety.

### BACKGROUND OF THE INVENTION

1. Field of Invention

The present application generally relates to processing search queries and, more particularly, to methods and systems for processing search queries using local caching and predictive fetching of results from a remote server to offset network latencies during incremental searching.

2. Description of Related Art

There are many user-operated devices such as mobile phones, PDAs (personal digital assistants), personal media players, and television remote control devices that have small keypads for text input. Largely because of device size restrictions, a full “QWERTY” keyboard often cannot be provided. Instead, a small keypad is provided having only a limited number of keys, which are overloaded with alpha-numeric characters.

FIG. 1 illustrates a common twelve-key keypad interface found in many cell phones and other mobile devices, and also in many television remote control devices. The keypad 10 includes twelve keys 12, most of which are overloaded with multiple alpha-numeric characters or functions. The same key can be used to enter different characters. For instance, the “2” key can be used to enter the number “2” and the letters “A”, “B” and “C”.

Text entry using such a keypad with overloaded keys can result in an ambiguous text entry, which requires some type of a disambiguation action. For instance, with a multi-press interface, a user can press a particular key multiple times in quick succession to select a desired character (e.g., to choose “B”, the user would press the “2” key twice quickly, and to choose “C”, the user would press the key three times). Alternatively, text entry can be performed using T9 and other text input mechanisms that provide vocabulary based completion choices for each word entered. Neither of these methods is however particularly useful for performing searches because of the number of steps needed to get to the result. One deficiency of the multi-press interface is that too many key strokes are needed. A drawback of applying a vocabulary based word completion interface is the need for the additional step of making a choice from a list of all possible word matches generated by the ambiguous text input. Furthermore vocabulary based word disambiguation systems are designed typically for composition applications (as opposed to search applications) where user explicitly disambiguates each word by performing a word completion action to resolve that word before proceeding to the next word in the composition.

The cumbersome text entry interface on mobile and other devices makes incremental searching a particularly convenient way of finding desired information. With incremental searching, the user-operated device returns results for each character of the search query entered by the user, unlike non-incremental search systems where the user has to enter the complete query string prior to initiating the search. In addition to facilitating the return of results without having to enter the full query string, incremental searching also enables the user to recover from an erroneous input even before the entire query string is fully input. This is a significant improvement over non-incremental search systems where the user often discovers an error only after submitting a fully formed query to the server.

Mobile devices such as phones and PDAs communicate over wireless networks, which typically have high network latencies, making incremental searching unfavorable. In particular, these networks have perceptible startup latencies to establish data communication links on wireless networks. Additionally, the network round trip latencies are perceptible even on networks with moderate to high bandwidth (>=100 kbps) from server to the mobile device. For instance the latency on a CDMA 1xRTT network could be greater than 600 msec (milliseconds). A GSM EDGE network could have latency as high as 500 msec. It has been found that latency in server responses exceeding 200-300 msec after the user types in a character is perceptible to users. These latencies result in a poor user experience when performing incremental searching with wireless mobile devices.

Perceptible network latencies also exist in wired networks. For instance, when using a personal computer (located, e.g., in the U.S.) for retrieving data from a server located a large distance away (e.g., in India), roundtrip latencies can be about 200 ms even with high speed network connections. These perceptible latencies diminish the user experience in performing incremental searching.

### BRIEF SUMMARY OF EMBODIMENTS OF THE INVENTION

In accordance with one or more embodiments of the invention, a method and system are provided for offsetting network latencies in an incremental processing of a search query entered by a user of a device having connectivity to a remote server over a network. The search query is directed at identifying an item from a set of items. In accordance with the method and system, data expected to be of interest to the user is stored in a local memory associated with the device. Upon receiving a key entry or a browse action entry of the search query from the user, the system searches the local memory associated with the device to identify results therein matching the key entry or browse action entry. The results identified in the local memory are displayed on a display associated with the device. Also upon receiving a key entry or a browse action entry of the search query from the user, the system sends the search query to the remote server and retrieves results from the remote server matching the key entry or browse action entry. The results from the remote server are merged with the results from the local memory for displaying on the display. The process is repeated for additional characters or browse actions entered by the user when he or she does not find the desired item on the display.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

For a more complete understanding of various embodiments of the present invention, reference is now made to the following descriptions taken in connection with the accompanying drawings in which:

FIG. 1 illustrates a keypad with overloaded keys in accordance with the prior art.

FIG. 2 is a simplified illustration of a search system in accordance with one or more embodiments of the invention.

FIG. 3 illustrates device configuration options for a device for performing searches in accordance with one or more embodiments of the invention.

FIG. 4 illustrates an exemplary data structure that can be used for incremental searching in accordance with one or more embodiments of the invention.

FIG. 5 is a flow chart illustrating an exemplary method for finding search results in accordance with one or more embodiments of the invention.

FIG. 6 is a simplified illustration of an exemplary mobile device interface used to perform incremental searching in accordance with one or more embodiments of the invention.

FIG. 7 illustrates the various exemplary user input states the user can transition through to arrive at a desired result in accordance with one or more embodiments of the invention.

FIG. 8 illustrates an example of local search and client-server interactions on a time line in accordance with one or more embodiments of the invention.

FIG. 9 illustrates creation of a local cache of a predictive fetch stream or search results from the remote server in accordance with one or more embodiments of the invention. The local cache in this illustration is a small subset of the server incremental search data structure.

Like reference numerals generally refer to like elements in the drawings.

### DETAILED DESCRIPTION OF THE PREFERRED EMBODIMENTS

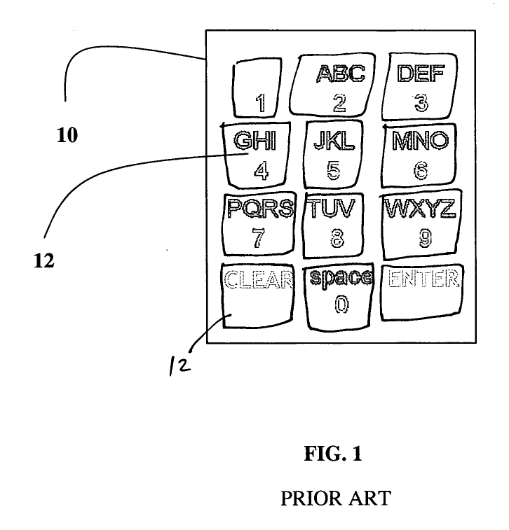

Briefly and as will be described in further detail below, various embodiments of the present invention are directed to methods and systems for offsetting network startup and/or roundtrip latencies during incremental searching performed using client devices connected to a remote server over a communication network. The latencies are offset using a predictive fetch scheme and local caching of results on user operated client devices. The local cache (or other memory) on the client device can be used to store a portion of the top results from searchable data spaces in the system. This cache can be searched to allow the user to see results generally instantly on inputting the first character or browse action of the query, which can be even before that device has established connection with the server. Also, upon entry of the first character or browse action of the query, the client device begins to dynamically and predictively fetch from the remote search server results pertinent to the user input expected to be of interest to the user. The choice of results to be fetched can be based on various criteria as will be described below. The remote server results are merged with the local cache results. The remote server predictive fetching operation is continued for any subsequent user input, making use of the time gap between each character entry or browse action performed by the user. This input driven predictive fetch operation from server enables the user to see results with reduced latency on average. The data fetch sequence also preferably adapts over time to the user's typical information finding behavior, which could be exclusively or a combination of text entry and browse actions. On devices with multiple alphabets overloaded on the same key (as shown, e.g., in FIG. 1), the predictive fetch scheme can also address the ambiguity of the input character.

The predictive fetch method described in accordance with various embodiments of the invention can function like a continuous user-input driven media stream compensating for the network round trip latencies and fluctuations, enabling the user to see the results in real time with the entry of each character or browse action constituting the input query. Furthermore, in accordance with one or more embodiments of the invention, the predictive fetched results can serve as a cache for subsequent user queries, further reducing perceived latencies.

In accordance with one or more embodiments of the invention, the server can dispatch during a predictive fetch or at another time, results that are predicted in advance to be highly requested query spikes, thus reducing server overloads and response degradation during the actual occurrence of the information query spikes.

Various embodiments of the present invention are particularly suited for use with mobile devices (such as cellular phones, PDAs, digital radios, personal media players and other devices) used in communications networks having high latency. The system however can also be used with various other devices communicating on a network such as PCs, television sets, and desk phones having a limited display space.

Search queries entered by users on the user-operated devices can include both text input comprising a set of characters or a browse action. A browse action can include a node descend through a node hierarchy (e.g., a set of categories and subcategories) or navigation of a linear list of nodes. The search queries entered by users are directed at identifying an item from a set of items. Each of the items has one or more associated descriptors or metadata. The descriptors can include words in the name of the item or other information relating to the item. For example, if the item is a restaurant, the descriptors can include the name of the restaurant, the type of food served, price range, and the location of the restaurant. In a television application, the item can be a television content item such as a movie or television program, and the descriptors can be information on the title of the movie or program, the cast, directors, and other keywords and descriptions of the movie or program.

If the user-operated device includes an ambiguous text input interface, the user can type in a search query by pressing overloaded keys of the text input interface once to form an ambiguous query string. In accordance with one or more embodiments of the invention, in an ambiguous text input system, the search space at both the remote server and the client device can be initially indexed by performing a many-to-many mapping from the alphanumeric space of terms to numeric strings corresponding to the various prefixes of each alphanumeric term constituting the query string. In a numeric string, each alphanumeric character in the string is replaced by its corresponding numeric equivalent based on, e.g., the arrangement of characters on the commonly used twelve-key reduced keypad of the type shown in FIG. 1. This mapping scheme enables the system in accordance with one or more embodiments to incrementally retrieve results matching the ambiguous alphanumeric input query, as the user types in each character of the query. The user does not have to explicitly specify the termination of each term to assist the system in disambiguating the input query; instead, the user only enters an input query that includes prefix substrings from one or more terms.

There are numerous possible applications for the search techniques described herein including, e.g., assisting users of mobile devices such as cell phones and PDAs in finding or identifying desired items in various databases (e.g., performing searches in directories of people or businesses, searching for and purchasing products/services like airline tickets and groceries, searching through transportation schedules such as airline schedules, searching for movies being shown at theaters, and searching for audio/video content) or for assisting television viewers in identifying desired television content items and channels.

In the context of television systems, the term “television content items” can include a wide variety of video/audio content including, but not limited to, television shows, movies, music videos, or any other identifiable content that can be selected by a television viewer. Searching for television content items can be performed across disparate content sources including, but not limited to, broadcast television, VOD, IPTV, and PVR (local and network).

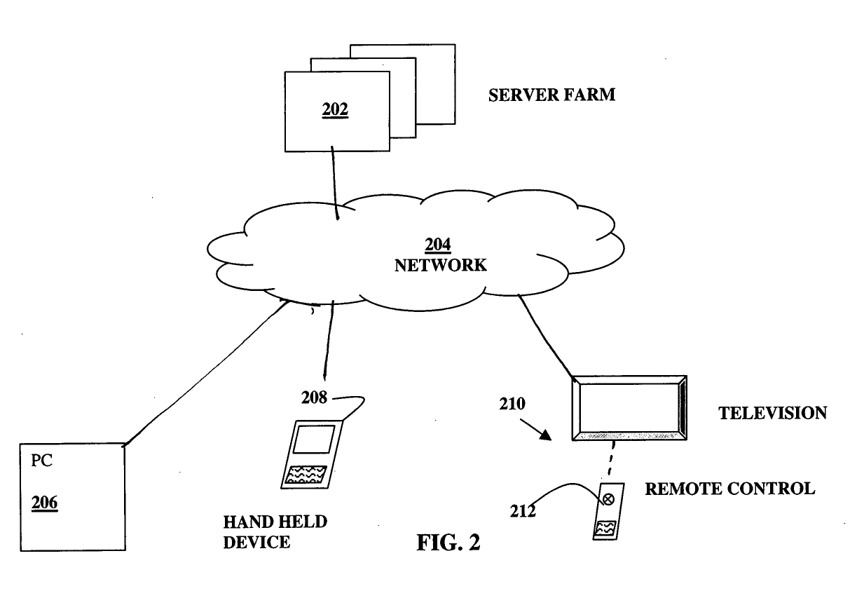

FIG. 2 schematically illustrates an overall system for performing searches with reduced text entry using various devices in accordance with one or more embodiments of the invention. The system includes a server farm or system 202, a network 204, and examples of various client devices 206, 208, 210 operated by users having text input interfaces. As will be described below, in accordance with various embodiments of the invention, search queries entered by users on the devices 206, 208, 210 are processed by the devices and by the server.

The network 204 transmits data between the server 202 to the devices 206, 208, 210 operated by the users. The network 204 could be wired or wireless connections or some combination thereof. Examples of possible networks include computer networks, cable television networks, satellite television networks, IP-based television networks, and mobile communications networks (such as, e.g., wireless CDMA and GSM networks).

The search devices could have a wide range of interface capabilities. A device, e.g., could be a hand-held mobile communications device 208 such as a phone or PDA having a limited display size and a reduced keypad with overloaded keys or a full QWERTY keypad. Another type of search device is a television system 210 with a remote control device 212 having an overloaded keypad or a full QWERTY keypad. Another possible search device is a Personal Computer (PC) 206 with a full QWERTY or reduced keyboard and a computer display.

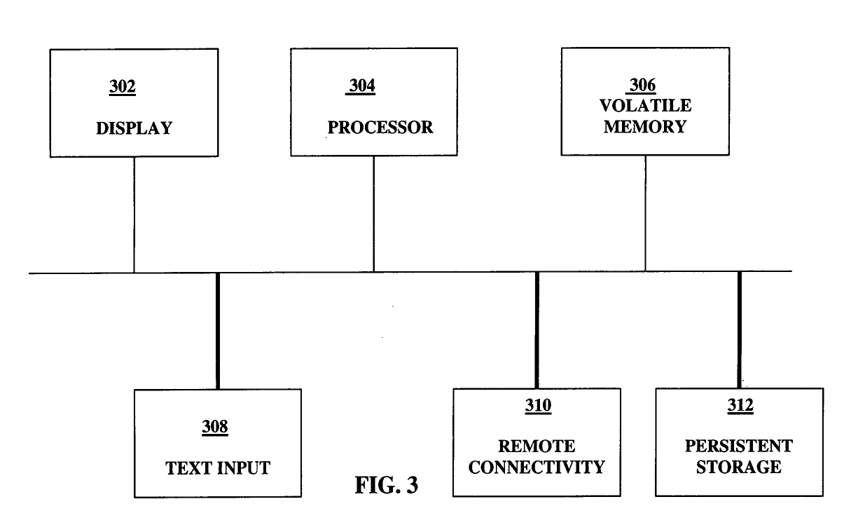

FIG. 3 illustrates an exemplary configuration for a client device in accordance with various embodiments of the invention. A device can have a display 302, a processor 304, volatile memory 306, text input interface 308, remote connectivity 310 to the server 202 through the network 204, and a persistent storage 312. The persistent storage 312 can be, e.g., a removable storage element such as SD, SmartMedia, CompactFlash card etc.

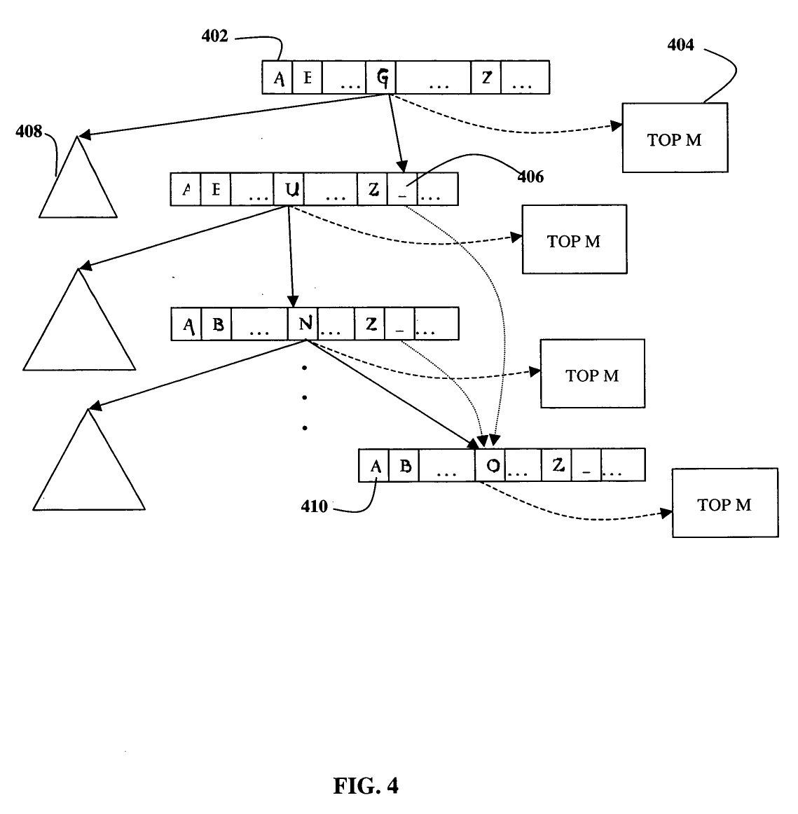

FIG. 4 illustrates an example of a data structure that enables searching using variable prefix strings of characters of search queries. (Additional examples of data structures used in performing searches are shown in U.S. patent application Ser. No. 11/136,261 entitled “Method and System for Performing Searches for Television Programming using Reduced Text Input,” which is incorporated by reference herein in its entirety.) The FIG. 4 illustration uses a trie data structure 402 to index the prefix strings. Each character in the trie (such as the space character 406) points to a set of top M 404 records that contains the most popular terms that begin with the prefix corresponding to the path from the root to that character. The ordering could be governed, e.g., by popularity, temporal relevance, location relevance, and personal preference. The TOP M records corresponding to every node in the trie may be placed in memory that enables quick access to them. The value of M may be determined by factors such as the display size of the devices from which search would be done and the available memory capacity of the server or client system where the search metadata are stored. Each character in the trie also points to a container 408 that holds all records following the TOP M. The container 408 may be also be cached in memory or stored in secondary storage. For the multi-term entity “guns of navarone”, two new prefix strings (in addition to the previous entity), “g_ of navarone” and “gu_ of navarone” are present in the trie. The prefix strings “g_” and “gu_” both point to node starting the next word “o” 410. While the figure illustrates a fan out of 26 for alphabets, it could also have a 10 fan-out to address ambiguous input from a phone with an overloaded keypad where multiple alphabets and a numeric value map to the same physical key.

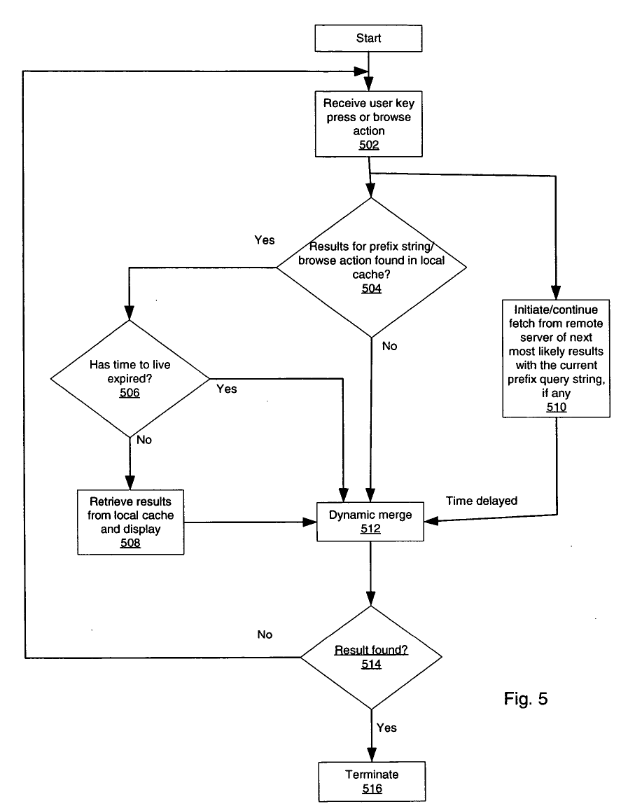

FIG. 5 is a flow chart illustrating the processing of a search query in accordance with one or more embodiments of the invention. The flow chart shows the process of a user starting a new search, entering characters or a browse action, and arriving at a desired result.

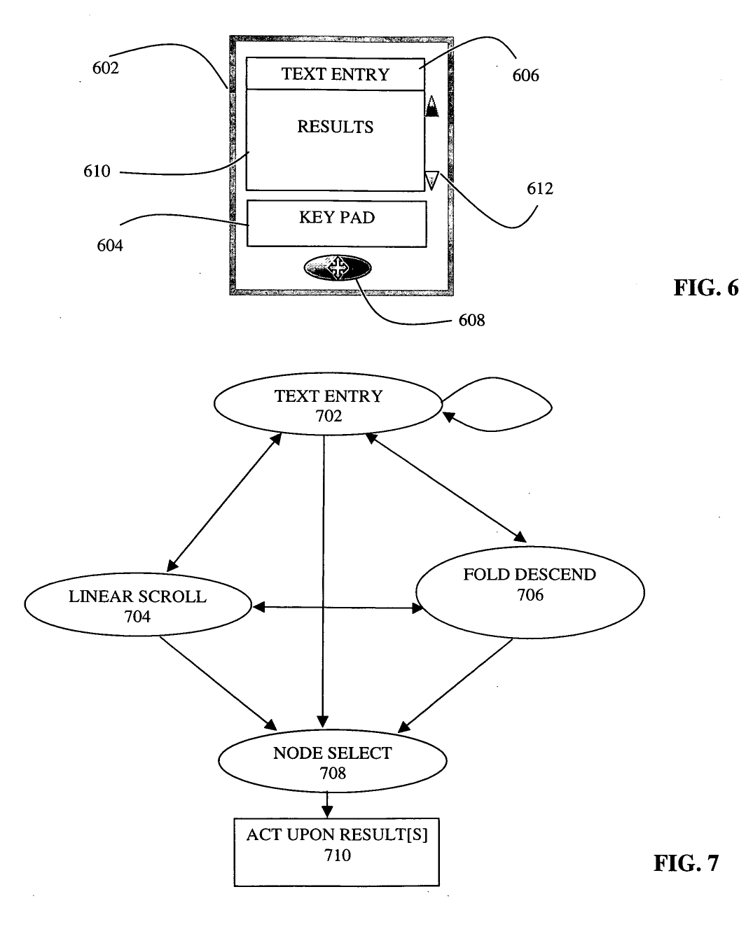

The user inputs a character or performs a browse action (e.g., descending down a node or traversing a linear list of nodes) at step 502 using, e.g., a mobile device user interface shown in FIG. 6.

The local cache on the device is searched at step 504 to determine if there is matching data, i.e., search results for the user's input. Identifying matching data can be performed using, e.g., a trie structure search of the type shown in FIG. 4.

If matching data are found for the user search query, then an additional optional check 506 can be performed to determine the “freshness” the resident cache data. Certain types of cached data such as, e.g., stock quotes, may become stale and not have any practical value after a given time period. If there is matching cached data that is not stale, the data are displayed to the user at 508, allowing the user to view and select a displayed result.

In response to the user input at step 502 and generally parallel to the local cache search operation 504, the user input is sent to a remote server in a predictive fetch operation at step 510. The results of the search performed at the remote server are merged with any local cache results at step 512. The merging is time delayed because the results received from the remote server will be typically received after the results from the local cache search are retrieved and displayed. The data are preferably merged and displayed in a manner that is not overly intrusive or disruptive to the usage of the device since the user may already be viewing local cache results. One way of merging the results can be to append or prepend the results of the server fetch operation to the end or beginning, respectively, of the results from the local cache. Another way to merge the results is to fold the results from the remote server into results displayed from local cache. Duplicate results from the remote server are preferably ignored during merging.

At step 514, a check is made to determine whether the user has found the desired item in the displayed results. If so, the process terminates at step 516. If not, the user can enter an additional character in the search query text or perform another browse action again at step 502, repeating the process described above.

The choice of results for the predictive fetch stream from the remote server can be based on one or more given criteria. The criteria can include one or a combination of some or all of the following: (1) the personalization preferences of the user, (2) the popularity of particular items, (3) the temporal and location relevance of the items, (4) breadth of spread of results across the alphabets of the language used for searches (since in a given language certain sequences of characters will appear more frequently in words than others), and (5) the relevance of terms (in relation to the popularity of the containing item) having the character entered by the user in that ordinal position. This stream can be dynamically adapted to match the incremental query input by the user, by walking down a trie data structure along the path of the prefix string entered by the user. For example, in searching for the movie entitled “Guns of Navarone”, if the user enters the query string “GU NAV”, a trie walk can be done down the path “GU NAV” as illustrated in FIG. 4. As the server receives each prefix query string, it streams the top records from that node based, e.g., on the five predictive fetch criteria mentioned above.

The personalization preferences of the user can be based, e.g., on user preferences, both explicitly and implicitly defined. Preferences can be implicitly defined based on repetitive user behavior. For instance, if a given user performs a search for the price of a particular stock at a certain time every morning, the system can provide a high rank to matching results relating to said stock.

FIG. 6 is a simplified illustration of a mobile device 602 interface for performing incremental searches. The user can enter text using a keypad 604, which may have overloaded keys similar to the 12-keypad in FIG. 1. The entered text can be displayed in the text field 606. The navigation interface on the device can be a navigation button 608 that facilitates reduced movement in horizontal and vertical direction. The results are displayed in the results area 610 corresponding to the input incremental text query or browse action. The user can scroll through the results using a scroll interface 612.

FIG. 7 illustrates the various states of user input a user could freely transition in order to get to a desired result. The user has the freedom to choose either one or a combination of: text entry and browse action to find results of interest. The actual path taken however can be influenced by both the user's intent and the results that are displayed. For instance, the user may start by entering text at 702, and may scroll through the displayed results at 704, pick a non-terminal node and traverse the children of the non-terminal at 706. When the user discovers a result, he can select it at 708 and perform an appropriate action at 710. The predictive fetch stream data can be dynamically adjusted to respond to each one of these different actions: (1) text entry (2) linear scroll and (3) fold descend, as will described below.

In the case of text entry, the choice of results displayed can be based upon given criteria such as the five predictive fetch criteria described above. In one or more embodiments of the invention, a server trie walk is done (as shown, e.g., in FIG. 4), and the top results at each node are streamed to the client. The streamed results can also contain sufficient information for the client device to recreate a trie structure out of the streamed results. So, in addition to displaying the streamed results, the results can be stored at the client device in a trie structure similar to the server. This enables client device to do a local trie walk on the predictive fetched results and retrieve the results, thereby enabling the client cache to function like a local server proxy (also described below in connection with FIG. 9). For instance, when the user enters “GU”, the client could receive results from the server for top records on the node “GU”. So if the user enters “GU_” (“_” is used in the place of space here for illustrative purposes), the local trie walk down “GU_” is done and the top results at this node are displayed to the user. The server could incrementally send only the new records that were not sent earlier during the trie descend to more efficiently utilize network bandwidth.

In the case of fold descend, the local server proxy in coordination with the remote server can fetch children of all non-terminals that are rendered on the display area. These results are fetched after fetching the top results needed for displaying in the display window 501A.

In the case of a linear scroll, the local server proxy in coordination with the remote server, can fetch results from the remote server that are not displayed in the results window. In the scenario where the displayed results are mostly folds, predictive fetching of the children of the folds can be done before linear scroll. In other cases, the linear scroll results are fetched before fetching the top child results of folds visible in the display window. These fetch sequences (trie walk fetch, linear scroll results fetch, folded children fetch) are preferably adapted over time to match the typical user's information finding behavior. For instance, on a device operated by a user who typically does not descend down folds but enters multi prefix queries, the system would perform trie walk fetch (with emphasis on results spread over all the alphabets) and linear scroll fetch. As another example, for a user who typically browses after the first text entry, the system could prioritize the fold fetch after a text entry fetch.

In accordance with one or more embodiments of the invention, the predictive fetch sequence can also be influenced by the device capabilities and the mode of text entry. For example, on mobile devices where a 12-key keypad (e.g., of the type shown in FIG. 1) is being used and the user is entering text in triple-tap or multi-press mode (e.g., the user presses once on the ‘2’ key once for ‘A’, twice for ‘B’, and thrice for ‘C’), the client may either decide to wait until the triple tap sequence is complete, or send each character as they come in, so that the server can initiate a predictive fetch with the knowledge of the key that is being currently pressed. The decision to buffer or send all characters can be made based on the available bandwidth of the device. For example, when the bandwidth is low, characters could be accrued within the multi-press period (approximately 165 msec) and the multi-press timeout period (approximately 1500 msec) before sending the character stream upstream to the remote server. This additional character input latency that can be leveraged off in a multi-press input method could go as high as 1830 msec as given by the following Fitt's equation (see Silverberg et al., “Predicting Text Entry Speed On Mobile Phones,” Proceedings Of The ACM Conference On Human Factors In Computing Systems—Chi 2000. Pp. 9-16):
Latency=MTᵣₑₚₑₐₜ+MTₖᵢₗₗ
where MTᵣₑₚₑₐₜ is 165*2=330 msec. 165 msec is the time between each consecutive press using index finger. MTₖᵢₗₗ is 1500 msec (the time for automatic timeout and selection of the currently entered character).

When using a single press mode of text entry with a limited keypad (e.g., the 12-key keypad shown in FIG. 1) with overloaded keys, the predictive fetch stream can, in addition to criteria such as the five-point criteria described above, prioritize results for all the overloaded characters on the key pressed by the user. This priority could be naturally captured in a 10 fanout trie, where each node, has results for all overloaded characters represented by that node.

In accordance with one or more embodiments of the invention, in addition to user-input driven data predictive fetching, the server may on its own also send, time permitting, data that are projected to be information spikes in those areas of interest to the user. For instance, if a popular movie is being released, and the user is observed to have a preference for that genre of movies, information about that movie could automatically be sent to the user device. This type of predictive fetching of data, in addition to eliminating the response latency, has the benefit of reducing server overload during the actual occurrence of the information spike. Such predictive fetching and caching can also be done to address the initial startup latency inherent in most communication networks. The size of this cache can be dependant on the available client memory resources. In another scenario when the user moves from a lower latency network such as an 1xRTT network to a higher latency network such as EVDO, the server could initiate a larger and prolonged download of data to offset the latency. This approach can be used even in contention based television cable networks where the uplink could get crowded. In this case, the server could perform a broadcast/multicast/unicast of data.

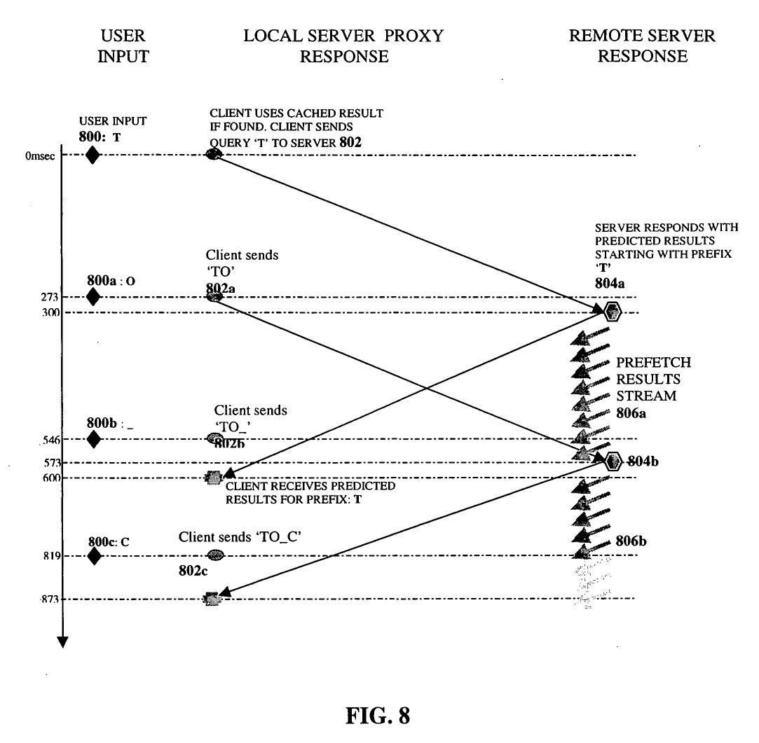

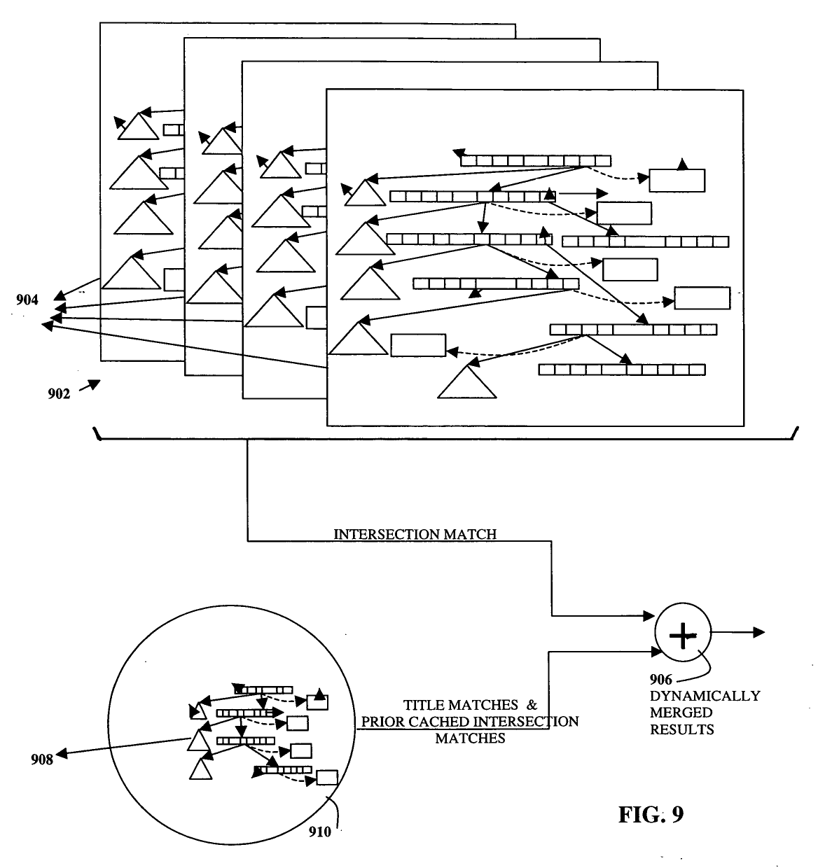

FIG. 8 illustrates the client-server interactions on a time line where the user input is occurring generally in parallel with a predictive fetch operation in accordance with one or more embodiments of the invention. While the only user input in the illustrated example is text entry, it should be noted that the same principle can be applied to the other forms of user input (e.g., a browse action such as scroll and fold descend). In the illustrated example, the user enters a query string “TO_C” (directed at identifying video content relating to the actor Tom Cruise) at 800, 800a, 800b, 800c, respectively. The local server proxy receives the input and returns the results, if any, to the client for display at 802, 802a, 802b, 802c as each character of the query is received. Generally in parallel to this, the device sends the input query to the remote server. The predictive fetch scheme exploits the latency between user character inputs to get data. The average latency between characters when using a mobile phone with the standard 12-key keypad (e.g., of the type shown in FIG. 1) to enter successive characters is 273 msec if the index finger is used and 309 msec if thumb is used. (See Silverberg et al., “Predicting Text Entry Speed On Mobile Phones,” Proceedings Of The ACM Conference On Human Factors In Computing Systems-Chi 2000). In the FIG. 8 example, the minimum of these latencies is used for inter-character latency in the user's text input (800a, 800b, 800c). In the illustration, a symmetric latency (upstream and downstream) of 300 msec is assumed, which is a worst case scenario of CDMA 1xRTT latency. When the server receives the character ‘T’ at 804a, it walks down the trie for “T” (note in the case of an ambiguous text input using a 12-key keypad, it would have been a descend down the node 8, on a 10 fanout trie), and fetches the most suitable record using criteria such as the five set criteria described earlier. These results are immediately streamed at 806a to client, where the streamed data packet contains the result data that will be shown in the display 610 (FIG. 6). In this example, the result data can include titles, followed optionally by a description of each result and other rich metadata. Similarly, when the server receives the other characters of the query like the character “O”, it determines and streams additional results at 860b to the client.

In the FIG. 8 illustration, the client receives the first packet of the predicted fetch stream at 600 msec. By this time, the user has already input two more characters “O” and a space character (indicated as an ‘_’ in the figure). If the local server proxy does not have any results to display for the prefix string “TO” or “TO_”, the user would perceive a latency. However, the predictive fetch scheme results from the server would start appearing at about 600 msec, and this may potentially contain matching results for the prefix strings “TO” and “TO_”. This would reduce perceived latency to 327 msec for “TO” and 54 msec for “TO_”, in contrast to the worst case latency of 600 msec from the point of text entry. Since the user typically perceives latencies only when exceeding the range 200-300 msec, the scheme significantly improves the user experience by reducing the perceived latency and even generally eliminating it in the best case scenario.

FIG. 9 illustrates an example of a local server proxy working in conjunction with a remote server to attempt to deliver results in real-time offsetting the round-trip latencies in accordance with one or more embodiments of the invention. A user's intent may either be to discover a particular item or document (e.g., a movie, “Guns of Navarone”) or an aggregation of items or documents (e.g., all Major League Baseball games of a particular team during a season). When using an incremental search for discovery, the input query may either be multiple prefix terms of an entity representing the item or document (e.g., “guns_navarone”, “tom_cruise” etc.) or multiple prefix terms of an intersection query (e.g., “tom_volleyball” to retrieve the movie “Castaway” featuring the actor Tom Hanks and a volleyball, “tc_nk” representing all the movies where Tom Cruise and Nicole Kidman acted together). The predictive fetch scheme in accordance with one or more embodiments of the invention retrieves results matching an entity query right from the press of the first character, by walking down a trie in the server farm 902 as each character is entered. Predictive fetch for intersection queries to the client is not ordinarily done, since there could potentially be a large amount of results. These results 904 can be retrieved in real-time from the server 902 and merged at 906 with the predictive fetched results 908 from the client 910 for entity matches.

Methods of processing search query inputs from users in accordance with various embodiments of the invention are preferably implemented in software, and accordingly one of the preferred implementations is as a set of instructions (program code) in a code module resident in the random access memory of a user-operated computing device. Until required by the device, the set of instructions may be stored in another memory, e.g., in a hard disk drive, or in a removable memory such as an optical disk (for eventual use in a CD ROM) or floppy disk (for eventual use in a floppy disk drive), or downloaded via the Internet or some other network. In addition, although the various methods described are conveniently implemented in a computing device selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

1-46. (canceled)

47. A user-interface system for a handheld control system and a remote content server having a large set of content items for user selection and activation, the user-interface system comprising:
a local cache of content items on the handheld control system;
local selection logic on the handheld control system for receiving alphanumeric selection actions from the user to specify one or more prefixes of descriptive terms to identify a desired content item, the local selection logic including logic to incrementally find content items from the local cache in response to each alphanumeric selection action by matching the user-entered prefixes with descriptive terms associated with the content items in the local cache;
a remote catalog on the remote content server having a large set of user-selectable and user-activatable content items;
remote selection logic, cooperating with the local selection logic, and including logic to query the remote catalog with user-entered prefixes to incrementally find content items on the remote catalog having descriptive terms associated therewith matching the user-entered prefixes;
presentation logic on the handheld control system for merging the results from the remote selection logic and the local selection logic and ordering the results for presentation in accordance with one or more criteria, and including logic to display the results on a display device as they become available and are merged so that the local selection logic results are presented substantially immediately upon user-entry of alphanumeric selection actions and the remote selection logic results are presented as they are received from the remote selection logic.

48. The system of claim 47, wherein each alphanumeric selection action is a key press, each key corresponding to a set of one or more alphanumeric characters, the key presses forming an ambiguous text input.

49. The system of claim 47, wherein the logic to query the remote catalog includes logic to anticipate subsequent alphanumeric selection actions by the user to predictively fetch content items on the remote catalog in accordance with the anticipated alphanumeric selection actions so that content items of interest are provided to the presentation logic.

50. The system of claim 49, wherein the logic to anticipate subsequent alphanumeric selection actions is responsive to at least one of personalized user preferences, popularity of the content item, temporal relevance of the content item, location relevance of the content item, recency of the content item, and relevance of the descriptive terms to the content items of the results.

51. The system of claim 49, wherein the logic to anticipate subsequent alphanumeric selection actions is responsive to a frequency of occurrence of character sequences in the language used for the user-entered prefixes.

52. The system of claim 49, wherein the logic to anticipate subsequent alphanumeric selection actions is responsive to predictive descriptive terms formed from the user-entered prefixes based on adding characters to the user-entered prefixes according to a frequency of occurrence of character sequences in the language used for the user-entered prefixes.

53. The system of claim 47, wherein the logic to query the remote catalog uses a trie data structure or a term intersection process or a combination thereof.

54. The system of claim 47, wherein the logic to query the remote catalog is on the remote content server.

55. The system of claim 47, wherein the one or more criteria include at least one of personalized user preferences, popularity of the content item, temporal relevance of the content item, location relevance of the content item, freshness of the content item, breadth of spread of results across alphabets of a language of the descriptive terms, and relevance of the descriptive terms to the content items of the results.

56. The system of claim 47, wherein selected remote selection logic results are displayed at the end of a selected list of local selection logic results.

57. The system of claim 47, wherein selected remote selection logic results are displayed at the beginning of a selected list of local selection logic results.

58. The system of claim 47, wherein selected remote selection logic results are folded into a list of selected local selection logic results.

59. The system of claim 47, wherein the handheld control system includes the display device.

60. The system of claim 47, wherein the display device is a display constrained device.

61. The system of claim 47, wherein the display device is a wireless communication device, a cell phone, a PDA, a personal media player, or a television.

62. The system of claim 47, wherein the handheld control system includes an input constrained device.

63. The system of claim 47, wherein the handheld control system is a wireless communication device, a cell phone, a PDA, or a personal media player.

64. The system of claim 47, wherein the handheld control system includes a remote control device and a television interface device for connection to a television, the television interface device being responsive to the remote control device.

65. The system of claim 64, wherein the local cache of content items is on the television interface device.

66. The system of claim 64, wherein the local selection logic is on the television interface device.

67. The system of claim 64, wherein the logic to incrementally find content items is on the television interface device.

68. The system of claim 64, further comprising transmission logic on the television interface device for buffering the alphanumeric selection actions from the user and for transmitting at least one set of more than one alphanumeric selection action to be received by the remote selection logic.

69. The system of claim 68, wherein the number of alphanumeric selection actions buffered is a predetermined fixed number.

70. The system of claim 68, wherein the number of alphanumeric selection actions buffered is based on communication bandwidth available to the local user interface device.

71. The system of claim 47, wherein the remote content server comprises more than one server.

72. The system of claim 47, wherein the remote catalog comprises more than one catalog.

73. The system of claim 47, further comprising transmission logic on the handheld control system for buffering the alphanumeric selection actions from the user and for transmitting at least one set of more than one alphanumeric selection action to be received by the remote selection logic.

74. The system of claim 73, wherein the number of alphanumeric selection actions buffered is a predetermined fixed number.

75. The system of claim 73, wherein the number of alphanumeric selection actions buffered is based on communication bandwidth available to the local user interface device.

76. The system of claim 47, wherein the local cache includes content items that are expected to be of interest.

77. The system of claim 47, wherein a content item to be included in the local cache is transmitted to the handheld control system in advance of projected interest in the content item.

78. The system of claim 47, wherein selected content items from the remote selection logic results are added to the local cache.

79. The system of claim 47, wherein the content items include at least one of a product, a service, an audio/video item, or personal or business contact information.

80. The system of claim 47, wherein the alphanumeric selection action is a user browse action.

81. The system of claim 80, wherein the browse action comprises a linear scroll or a category descend.

82. The system of claim 80, wherein the one or more prefixes of descriptive terms are associated with categories of a hierarchy for organizing the content items present in at least one of the local cache or remote catalog.

83. The system of claim 82, wherein the results from at least one of the local selection logic or remote selection logic include categories matching the user-entered prefixes.

84. The system of claim 83, wherein the logic to query the remote catalog includes logic to anticipate subsequent browse actions by the user to predictively fetch at least one of the content items organized into the categories included in the results so that content items of interest are provided to the presentation logic.
